(19) United States
(12) Patent Application Publication
(10) Pub. No.: US 2026/0153329 A1
(43) Pub. Date: Jun. 4, 2026

(54) MEASUREMENT DEVICE

(71) Applicant: SANKYO SEISAKUSHO CO., Tokyo (JP)

(72) Inventor: Naoyuki TAKAHASHI, Kikugawa (JP)

(73) Assignee: SANKYO SEISAKUSHO CO., Tokyo (JP)

(21) Appl. No.: 19/123,825

(22) PCT Filed: Oct. 16, 2023
(86) PCT No.: PCT/JP2023/037360

§ 371 Date: Apr. 24, 2025

(30) Foreign Application Priority Data
Oct. 31, 2022 (JP) 2022-174062

(51) Int. Cl. G01B 21/24; G01C 9/02

(52) U.S. Cl. CPC G01B 21/24; G01C 9/02

(57) ABSTRACT

Provided is a measurement device for measuring the incline angle of a measurement surface with respect to a measurement reference plane. This measurement device comprises: a rotation mechanism; a support member capable of being rotated about a support member axis by the rotation mechanism; an angle detector for detecting the rotation angle of the support member; and an incline detector for detecting the incline angle of the support member with respect to a measurement reference plane, the incline detector being disposed on the support member. The measurement device is placed on a measurement surface. The rotation mechanism causes the support member to rotate such that the incline detector is substantially parallel to the measurement reference plane. The measurement device measures the incline angle of the measurement surface with respect to the measurement reference plane on the basis of the rotation angle of the rotation of the support member detected by the angle detector, and the incline angle detected by the incline detector.

### TECHNICAL FIELD

The present invention relates to a measurement device capable of directly, highly accurately, widely, and simply measuring an incline angle of a measurement surface with respect to a measurement reference plane.

### BACKGROUND ART

There are needs to directly and highly accurately measure an incline angle of any desired measurement surface on a workpiece mounting surface of a tilting rotary table, an end effector of a robot arm, or the like rotatable around an inclined rotation axis. The incline angle of the measurement surface can be measured using a reflecting mirror and laser placed on an inclined rotation axis as with a laser goniometer, an autocollimator, and the like. The incline angle of the measurement surface can also be measured using a rotary encoder. On the tilting rotary table, the rotary encoder, which cannot be placed on the workpiece mounting surface, is placed on the inclined rotation axis. On the end effector of the robot arm, the rotary encoder is similarly placed on the inclined rotation axis. The incline angle of the measurement surface can also be measured using a level gauge. The level gauge can be placed directly on the measurement surface.

PATENT LITERATURE 1 discloses an indexing device comprising: a turning table device; a support device, the turning table device and the support device being mounted on a common base; and a cradle which is supported by the turning table device and the support device via a pair of arms and on which a jig and a workpiece to be machined are mounted. A spindle is installed on the turning table device, being supported rotatably with respect to the frame and mounted on one of the arms via a rotary table, a detected ring making up part of a rotation detector adapted to detect a rotation angle of the spindle is mounted on the spindle, and a detection sensor making up part of the rotation detector is mounted on the frame.

### CITATION LIST

### Patent Literature

PATENT LITERATURE 1: JP-A-2012-20378
PATENT LITERATURE 2: JP-A-2006-98392
PATENT LITERATURE 3: JP-A-2011-99802
PATENT LITERATURE 4: JP-A-2011-99804

### SUMMARY OF INVENTION

### Technical Problem

When a reflecting mirror and a laser are used, on a tilting rotary table, there is a problem in that depending on the height position of the workpiece mounting surface, the center of the reflecting mirror and the center of the inclined rotation axis cannot be brought into alignment, the incline angle of the measurement surface cannot be measured with high accuracy, and the incline angle of the measurement surface can be measured only to the extent that the laser would not be blocked and cannot be measured in a wide range such as a 360-degree range. On the end effector of the robot arm, there is a problem in that even if the reflecting mirror is placed on the end effector, the end effector moves greatly from a laser irradiation position, making it impossible to measure the incline angle of the measurement surface, and consequently even though the reflecting mirror is placed on an inclined rotation axis of a joint, members from the joint to the end effector are deformed by gravity and/or loads, and consequently an incline angle of the joint measured by the reflecting mirror and the laser and an incline angle of the end effector, which is a measurement surface, do not match. When the rotary encoder is used, there is a problem in that on the tilting rotary table, the rotary encoder is placed on an inclined rotation axis of a drive unit adapted to tilt the workpiece mounting surface, and on the robot arm, even though the rotary encoder is placed on the joint, members from the rotary encoder to the workpiece mounting surface of the tilting rotary table and the end effector of the robot arm are deformed by gravity and/or loads, and consequently the incline angle measured by the rotary encoder and the incline angle of the measurement surface do not match, the rotary encoder cannot be placed on the workpiece mounting surface of the tilting rotary table and the end effector of the robot arm, and thus it is impossible to directly measure the incline angle of the measurement surface. When a level gauge is used, there is a problem in that a level gauge capable of measuring an incline angle with high accuracy on the order of 1/3600° or less has an extremely narrow measuring range such as −1° to +1°, and is not suitable for measuring an incline angle of a measurement surface in a wide range such as a 360-degree range.

On the indexing device disclosed in PATENT LITERATURE 1, members from the rotation detector adapted to detect the rotation angle of the spindle to the cradle on which a jig and a workpiece to be machined are mounted are subject to deformation under the weight of the jig, the workpiece to be machined, and the cradle, and consequently, the rotation angle measured by the rotation detector does not match the rotation angle of the cradle. This poses a problem in that the cradle cannot be positioned with high accuracy.

Thus, an object of the present invention is to solve the above problems and provide a measurement device capable of directly, highly accurately, widely, and simply measuring an incline angle of a measurement surface with respect to a measurement reference plane.

### Solution to Problem

According to one viewpoint of the present invention, a measurement device measuring an incline angle of a measurement surface with respect to a measurement reference plane includes, a rotation mechanism; a support member rotatable around a support member axis by means of the rotation mechanism; an angle detector detecting a rotation angle of the support member; and an incline detector placed on the support member and detecting an incline angle of the support member with respect to the measurement reference plane, wherein the measurement device is placed on the measurement surface, the rotation mechanism rotates the support member such that the incline detector is roughly parallel to the measurement reference plane, and the measurement device is configured to measure the incline angle of the measurement surface with respect to the measurement reference plane based on the rotation angle along with rotation of the support member detected by the angle detector and on the incline angle detected by the incline detector.

According to one specific example of the present invention, in the measurement device, the rotation mechanism rotates the support member such that the incline detector is parallel to the measurement reference plane based on the incline angle detected by the incline detector.

According to another specific example of the present invention, in the measurement device, the incline detector is a level gauge.

According to another specific example of the present invention, the measurement surface is configured to rotate around an inclined rotation axis; in the measurement device, the rotation mechanism rotates the support member along with rotation of the measurement surface; and the measurement device is configured to measure a rotation angle of the measurement surface by measuring the incline angle of the measurement surface with respect to the measurement reference plane along with rotation of the measurement surface.

According to another specific example of the present invention, the measurement device is placed on the measurement surface such that the support member axis is parallel to the inclined rotation axis.

According to another specific example of the present invention, in the measurement device, when the incline detector detects the incline angle of the support member with respect to the measurement reference plane, the rotation mechanism rotates the support member in one predetermined direction.

According to another specific example of the present invention, the measurement surface is configured to rotate based on a predetermined rotation angle; in the measurement device, the rotation mechanism rotates the support member according to the predetermined rotation angle; and the measurement device is configured to measure the incline angle of the measurement surface with respect to the measurement reference plane according to the predetermined rotation angle.

According to another specific example of the present invention, the measurement device further includes an incline sensor, wherein the rotation mechanism rotates the support member such that the incline angle of the support member with respect to the measurement reference plane, detected by the incline sensor, falls within a predetermined range; and when the incline angle detected by the incline sensor falls within the predetermined range, the measurement device is configured to measure the incline angle of the measurement surface with respect to the measurement reference plane based on the incline angle detected by the incline detector.

According to another specific example of the present invention, in the measurement device, the rotation mechanism rotates the support member while the measurement surface is rotating; and while the measurement surface is rotating, the measurement device is configured to measure the incline angle of the measurement surface with respect to the measurement reference plane.

According to another specific example of the present invention, the measurement surface is a first measurement surface; and after measuring a first incline angle of the first measurement surface with respect to the measurement reference plane, the measurement device is configured to be placed on a second measurement surface different from the first measurement surface, measure a second incline angle of the second measurement surface with respect to the measurement reference plane, and measure a relative difference in incline angle between the first measurement surface and the second measurement surface based on the first incline angle and the second incline angle.

### Advantageous Effects of Invention

According to the present invention, the measurement device can directly, highly accurately, widely, and simply measure the incline angle of the measurement surface with respect to the measurement reference plane.

Other objects, features, and advantages of the present invention will become apparent from the following description of the embodiments of the present invention taken in conjunction with the accompanying drawings.

### BRIEF DESCRIPTION OF DRAWINGS

FIG. 1A is a perspective view of a measurement device used to measure an incline angle of a measurement surface with respect to a measurement reference plane, where the measurement device is an embodiment of the present invention.

FIG. 1B is a perspective view of the measurement device according to the embodiment shown in FIG. 1A when viewed in a direction different from FIG. 1A.

FIG. 2 is a perspective view showing a state in which the measurement device according to the embodiment shown in FIG. 1A is placed on a tilting rotary table.

FIG. 3A is a sectional view showing a state in which the measurement device according to the embodiment shown in FIG. 1A is placed on a tilting rotary table.

FIG. 3B is a sectional view showing how the measurement surface has been rotated from the state shown in FIG. 3A.

FIG. 3C is a sectional view showing how a support member has been rotated from the state shown in FIG. 3B.

FIG. 4A is a sectional view showing a state in which the measurement device according to the embodiment shown in FIG. 1A is placed on an end effector of a robot arm.

FIG. 4B is a sectional view showing how the measurement surface has been rotated from the state shown in FIG. 4A.

FIG. 4C is a sectional view showing how the support member has been rotated from the state shown in FIG. 4B.

FIG. 5A is a perspective view showing a state in which the measurement devices according to the embodiment shown in FIG. 1A are placed on the measurement reference plane and a measurement surface.

FIG. 5B is a plan view showing a state in which the measurement devices according to the embodiment shown in FIG. 1A are placed on the measurement reference plane and the measurement surface.

FIG. 5C is a side view showing a state in which the measurement devices according to the embodiment shown in FIG. 1A are placed on the measurement reference plane and the measurement surface.

FIG. 6A is a sectional view showing how the measurement surface has been rotated from the state shown in FIG. 3A in a direction opposite the direction shown in FIG. 3B.

FIG. 6B is a sectional view showing how the support member has been rotated from the state shown in FIG. 6A in a direction opposite the direction shown in FIG. 3C.

FIG. 6C is a sectional view showing how the support member has been rotated from the state shown in FIG. 6B in the same direction as in FIG. 3C.

FIG. 7 is a perspective view of the measurement device according to the embodiment shown in FIG. 1A, where the measurement device further includes an incline sensor.

FIG. 8A is a perspective view showing a state in which the measurement device according to the embodiment shown in FIG. 1A is placed on an evaluation device.

FIG. 8B is a front view showing a state in which the measurement device according to the embodiment shown in FIG. 1A is placed on the evaluation device.

FIG. 8C is a front view showing a state in which the measurement device according to the embodiment shown in FIG. 1A is placed on another evaluation device.

FIG. 9A is a graphic chart of positioning command angle versus angular measurement error concerning the measurement device of the present invention and a conventional measurement device placed on the evaluation device of FIG. 8B.

FIG. 9B is a graphic chart of differences in a positioning-command-angle versus angular-measurement-error relationship between the measurement device of the present invention and conventional measurement device placed on the evaluation device of FIG. 8B.

FIG. 9C is a graphic chart of positioning command angle versus angular measurement error concerning the measurement device of the present invention and conventional measurement device placed on the evaluation device of FIG. 8C.

FIG. 9D is a graphic chart of differences in a positioning-command-angle versus angular-measurement-error relationship between the measurement device of the present invention and conventional measurement device placed on the evaluation device of FIG. 8C.

### DESCRIPTION OF EMBODIMENTS

Embodiments according to the present invention will be described with reference to the drawings. However, the present invention is not limited to those embodiments.

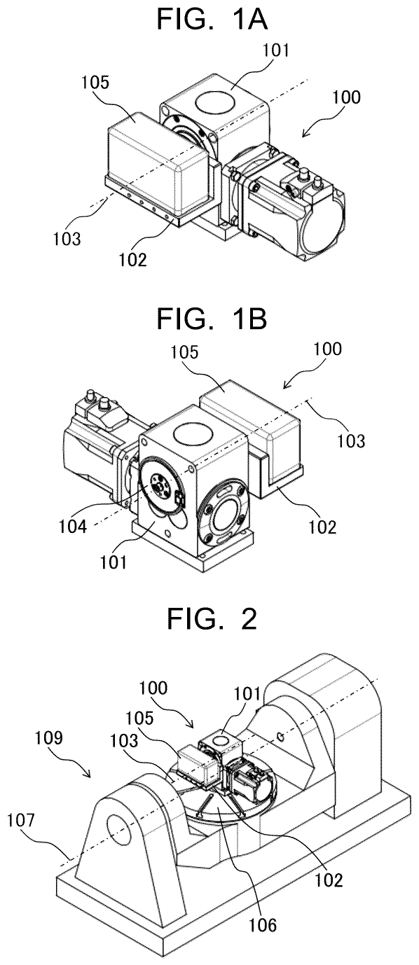

With reference to FIGS. 1A to 7, description will be given of a measurement device 100 used to measure an incline angle of a measurement surface 106 with respect to a measurement reference plane 108, where the measurement device 100 is an embodiment of the present invention. The measurement device 100 includes a rotation mechanism 101, a support member 102 rotatable around a support member axis 103 by means of the rotation mechanism 101, an angle detector 104 used to detect a rotation angle of the support member 102, and an incline detector 105 placed on the support member 102 and used to detect an incline angle of the support member 102 with respect to the measurement reference plane 108. To rotate the support member 102, the rotation mechanism 101 may be equipped with a motor, a reducer, a cam mechanism, and the like, but this is not restrictive, and it is sufficient if the rotation mechanism 101 can rotate the support member 102 or allow the support member 102 to be rotated manually. To detect a rotation angle of the support member 102, the angle detector 104 may be a rotary encoder, a resolver, an inductosyn, or the like, but this is not restrictive, and preferably the angle detector 104 is capable of detecting an rotation angle with high accuracy on the order of 1/3600 ° (1 arcsec) or less and, for example, may be an angle detector with a self-calibration function such as disclosed in PATENT LITERATURES 2 to 4. To detect the incline angle of the support member 102 with respect to the measurement reference plane 108, the incline detector 105 may be a level gauge, a level tube, an incline sensor, or the like, but this is not restrictive, and preferably the incline detector 105 is capable of detecting an incline angle with high accuracy on the order of 1/3600° or less. Note that the measurement reference plane 108 may be the ground or such an imaginary plane in space that will allow the incline detector 105 to detect an arbitrary angle of 1°, 10°, or the like with respect to the ground. To automatically measure the incline angle of the measurement surface 106 with respect to the measurement reference plane 108, the measurement device 100 may include a controller adapted to cause the rotation mechanism 101 to rotate the support member 102, cause the angle detector 104 to detect the rotation angle of the support member 102, and cause the incline detector 105 to detect the incline angle of the support member 102.

The measurement device 100 is placed on the measurement surface 106 for use to measure the incline angle with respect to the measurement reference plane 108. The measurement device 100 may be placed, for example, on the measurement surface 106 of a tilting rotary table 109 rotatable around an inclined rotation axis 107, on the measurement surface 106 on an end effector 111 of a robot arm 110, on the measurement surface 106 on a joint of the robot arm 110, or the like or placed on a fixed slope such as a first measurement surface 112, a second measurement surface 113, or the like. The rotation mechanism 101 rotates the support member 102 such that the incline detector 105 will be roughly parallel to the measurement reference plane 108. Here, the sentence that “the incline detector 105 will be roughly parallel to the measurement reference plane 108” means that the incline angle of the support member 102 with respect to the measurement reference plane 108 will be in a range of −10°to +10°, preferably in a range of −5°to +5°, more preferably in a range of −3° to +3°, and still more preferably in a range of −1°to +1°. In order for the incline detector 105 such as a level gauge to detect an incline angle with high accuracy on the order of 1/3600° or less, since the measuring range is extremely narrow, the rotation mechanism 101 needs to rotate the support member 102 such that the incline detector 105 can measure the incline angle within the measuring range. For example, when the measuring range of the incline detector 105 is −1° to +1°, the rotation mechanism 101 rotates the support member 102 such that the incline angle of the support member 102 with respect to the measurement reference plane 108 will fall within the range of −1°to +1°.

The measurement device 100 is configured to measure the incline angle of the measurement surface 106 with respect to the measurement reference plane 108, based on the rotation angle along with rotation of the support member 102 detected by the angle detector 104, as well as on the incline angle detected by the incline detector 105. In so doing, the rotation mechanism 101 may be configured to rotate the support member 102 such that the incline detector 105 will be parallel to the measurement reference plane 108 based on the incline angle detected by the incline detector 105, and the measurement device 100 may be configured to measure the incline angle of the measurement surface 106 with respect to the measurement reference plane 108 based on the rotation angle along with rotation of the support member 102 detected by the angle detector 104. For example, as the incline angle of the support member 102 with respect to the measurement reference plane 108 is detected by the incline detector 105, the rotation mechanism 101 may rotate the support member 102 such that the incline angle of the support member 102 with respect to the measurement reference plane 108 will be 0° and the measurement device 100 may measure the incline angle of the measurement surface 106 with respect to the measurement reference plane 108 based on the rotation angle along with rotation of the support member 102 detected by the angle detector 104.

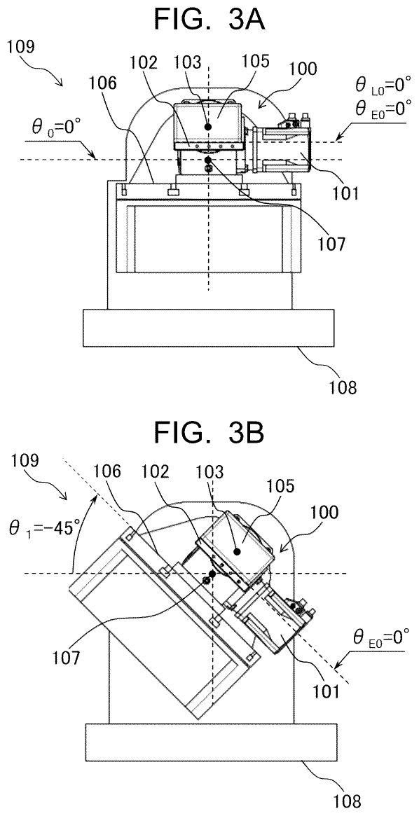

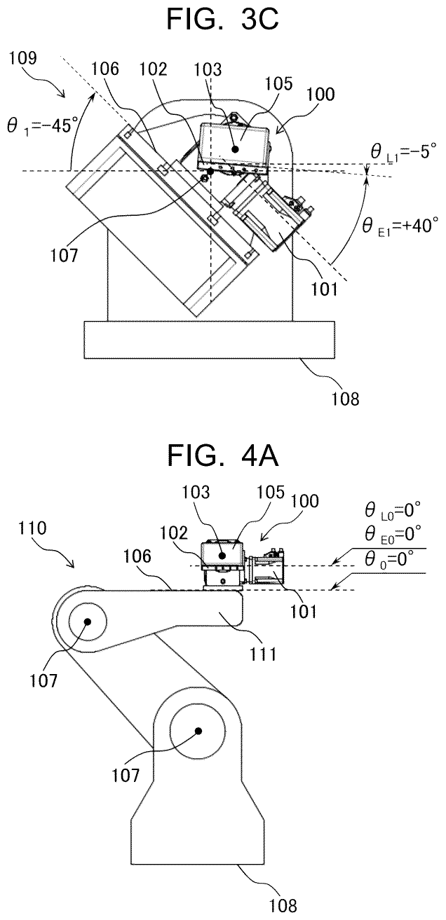

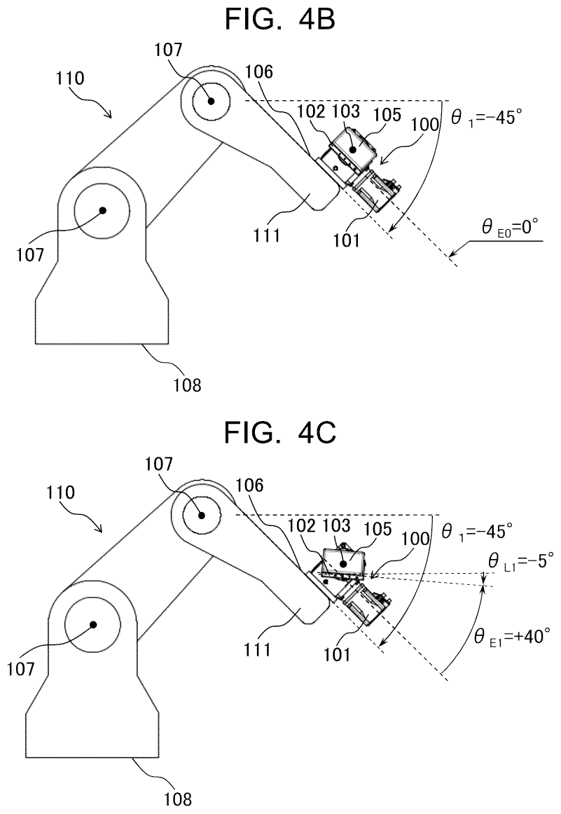

The measurement surface 106 may be configured to rotate around the inclined rotation axis 107. The measurement device 100 is placed on the measurement surface 106 such that the support member axis 103 will be parallel to the inclined rotation axis 107. For example, as shown in FIGS. 3A to 3C, by being placed on the measurement surface 106 of the tilting rotary table 109, the measurement device 100 may measure the incline angle of the measurement surface 106 with respect to the measurement reference plane 108 at each rotation angle of the measurement surface 106 around the inclined rotation axis 107, and as shown in FIGS. 4A to 4C, by being placed on the measurement surface 106 of the end effector 111 of the robot arm 110, the measurement device 100 may measure the incline angle of the measurement surface 106 with respect to the measurement reference plane 108 at each rotation angle of the measurement surface 106 around the inclined rotation axis 107. As shown in FIGS. 3A and 4A, at an initial incline angle θ₀ of the measurement surface 106, the rotation angle θ_{E0} of the support member 102 is detected by the angle detector 104 and the incline angle θ_{L0} of the support member 102 with respect to the measurement reference plane 108 is detected by the incline detector 105. In FIGS. 3A and 4A, the initial incline angle θ₀ is set such that the measurement surface 106 will be parallel to the measurement reference plane 108, but it is not always necessary to set the initial incline angle θ₀ such that the measurement surface 106 will be parallel to the measurement reference plane 108. Note that to facilitate understanding, the initial incline angle θ₀ may be set to 0°, and in that case, both the rotation angle θ_{E0} detected by the angle detector 104 and the incline angle θ_{L0} detected by the incline detector 105 may be set to 0°.

Next, as shown in FIGS. 3B and 4B, the measurement surface 106 is rotated around the inclined rotation axis 107 to a target incline angle θ₁. Then, as shown in FIGS. 3C and 4C, along with the rotation of the measurement surface 106, the rotation mechanism 101 rotates the support member 102 such that the incline detector 105 will be roughly parallel to the measurement reference plane 108, i.e., an incline angle θ_{L1} of the support member 102 with respect to the measurement reference plane 108 will be roughly equal to the incline angle θ_{L0}. The rotation mechanism 101 may rotate the support member 102 either in a same direction as a rotation direction of the measurement surface 106 or in a direction opposite the rotation direction of the measurement surface 106. At the target incline angle θ₁ of the measurement surface 106, a rotation angle θ_{E1} of the support member 102 is detected by the angle detector 104 and the incline angle θ_{L1} of the support member 102 with respect to the measurement reference plane 108 is detected by the incline detector 105. A rotation angle θ₁−θ₀ of the measurement surface 106 is given by −{(θ_{E1}−θ_{E0})−(θ_{L1}-θ_{L0})}. In this way, the measurement device 100 may be configured to measure the rotation angle of the measurement surface 106 by measuring the incline angle of the measurement surface 106 with respect to the measurement reference plane 108 along with the rotation of the measurement surface 106. For example, as shown in FIGS. 3C and 4C, if the rotation angle θ_{E0} detected at the initial incline angle θ₀ is 0°, the incline angle θ_{L0} is 0°, the rotation angle θ_{E1} detected at the target incline angle θ₁ is 40°, and the incline angle θ_{L1} is −5°; then the rotation angle θ₁−θ₀ of the measurement surface 106 is given by −{(40°−0°) (−5°−0°)}=−45°. Note that for the sake of convenience, a counterclockwise direction is designated as a positive direction and a clockwise direction is designated as a negative direction. If the support member 102 is rotated such that the incline angle θ_{L1} of the support member 102 with respect to the measurement reference plane 108 will become equal to the incline angle θ_{L0}, the rotation angle θ₁−θ₀ of the measurement surface 106 is given by −(θ_{E1}−θ_{E0}). This is effective in obtaining the rotation angle θ₁−θ₀ with high accuracy even if measurement linearity of the incline detector 105 is not good.

The rotation mechanism 101 may rotate the support member 102 clockwise and/or counterclockwise around the support member axis 103 in a range of between −360° and +360°. Consequently, even when the measurement surface 106 is rotated clockwise and/or counterclockwise around the inclined rotation axis 107 in a range of between −360° and +360°, the rotation angle of the measurement surface 106 can be measured. Regarding the incline angle of the measurement surface 106 with respect to the measurement reference plane 108 and the rotation angle of the measurement surface 106, available resolution and accuracy depend on the resolution and accuracy of the angle detector 104 and incline detector 105, and both the angle detectors 104 and the incline detectors 105 with a resolution of 1/3600° or less and an accuracy in a range of −1/3600° to +1/3600° are commercially available. The use of such angle detectors 104 and incline detectors 105 makes it possible to measure the incline angle of the measurement surface 106 with respect to the measurement reference plane 108 and the rotation angle of the measurement surface 106 directly on the measurement surface 106 with high accuracy on the order of 1/3600° or less, in a range as wide as 360°, and in a simple manner.

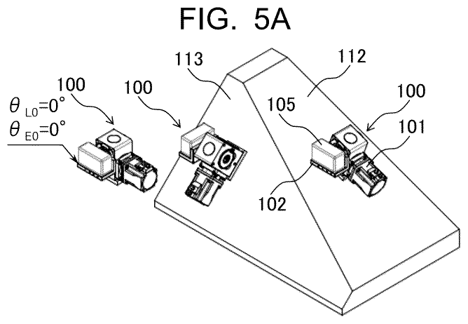

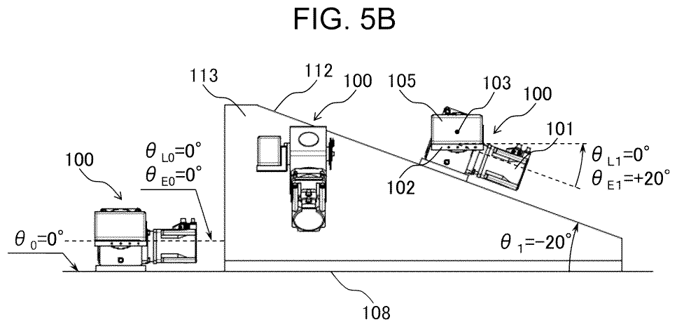

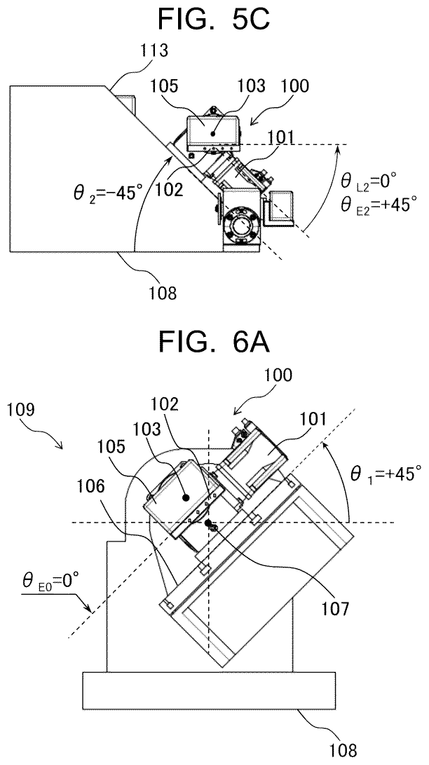

As shown in FIGS. 5A to 5C, the measurement device 100 may be placed first on the measurement reference plane 108. On the measurement reference plane 108, the rotation angle θ_{E0} of the support member 102 is detected by the angle detector 104 and the incline angle θ_{L0} of the support member 102 with respect to the measurement reference plane 108 is detected by the incline detector 105. The rotation angle θ_{E0} and incline angle θ_{L0} detected on the measurement reference plane 108 are both set to 0°, and the incline angle θ₀ of the measurement reference plane 108 is set to 0°. Next, as shown in FIGS. 5A and 5B, the measurement device 100 may be placed on the first measurement surface 112. The rotation mechanism 101 rotates the support member 102 according to the incline angle θ₁ of the first measurement surface 112 such that the incline detector 105 will be roughly parallel to the measurement reference plane 108, i.e., the incline angle θ_{L1} of the support member 102 with respect to the measurement reference plane 108 will become roughly equal to the incline angle θ_{L0}. At the incline angle θ₁ of the first measurement surface 112, the rotation angle θ_{E1} of the support member 102 is detected by the angle detector 104 and the incline angle θ_{L1} of the support member 102 with respect to the measurement reference plane 108 is detected by the incline detector 105. The first incline angle θ₁−θ₀ of the first measurement surface 112 with respect to the measurement reference plane 108 is given by −{(θ_{E1}−θ_{E0})−(θ_{L1}−θ_{L0})}. In this way, the measurement device 100 may be configured to measure the first incline angle θ₁−θ₀ of the first measurement surface 112 with respect to the measurement reference plane 108. For example, as shown in FIGS. 5A and 5B, if the rotation angle θ_{E1} and incline angle θ_{L1} detected on the first measurement surface 112 are 20° and 0°, respectively, the first incline angle θ₁−θ₀ of the first measurement surface 112 with respect to the measurement reference plane 108 is given by −{(20°−0°)−(0°−0°)}=20°. Note that for the sake of convenience, a counterclockwise direction is designated as a positive direction and a clockwise direction is designated as a negative direction.

Next, as shown in FIGS. 5A and 5C, the measurement device 100 may be placed on the second measurement surface 113. The rotation mechanism 101 rotates the support member 102 according to an incline angle θ₂ of the second measurement surface 113 such that the incline detector 105 will be roughly parallel to the measurement reference plane 108, i.e., the incline angle θ_{L2} of the support member 102 with respect to the measurement reference plane 108 will become roughly equal to the incline angle θ_{L0}. At the incline angle θ₂ of the second measurement surface 113, the rotation angle θ_{E2} of the support member 102 is detected by the angle detector 104 and the incline angle θ_{L2} of the support member 102 with respect to the measurement reference plane 108 is detected by the incline detector 105. The second incline angle θ₂−θ₀ of the second measurement surface 113 with respect to the measurement reference plane 108 is given by −{(θ_{E2}−θ_{E0})−(θ_{L2}″θ_{L0})}. In this way, the measurement device 100 may be configured to measure the second incline angle θ₂−θ₀ of the second measurement surface 113 with respect to the measurement reference plane 108. For example, as shown in FIGS. 5A and 5C, if the rotation angle θ_{E2} and incline angle θ_{L2} detected on the second measurement surface 113 are 45° and 0°, respectively, the second incline angle θ₂−θ₀ of the second measurement surface 113 with respect to the measurement reference plane 108 is given by −{(45°−0°)−(0°−0°)}=−45°. Note that for the sake of convenience, a counterclockwise direction is designated as a positive direction and a clockwise direction is designated as a negative direction.

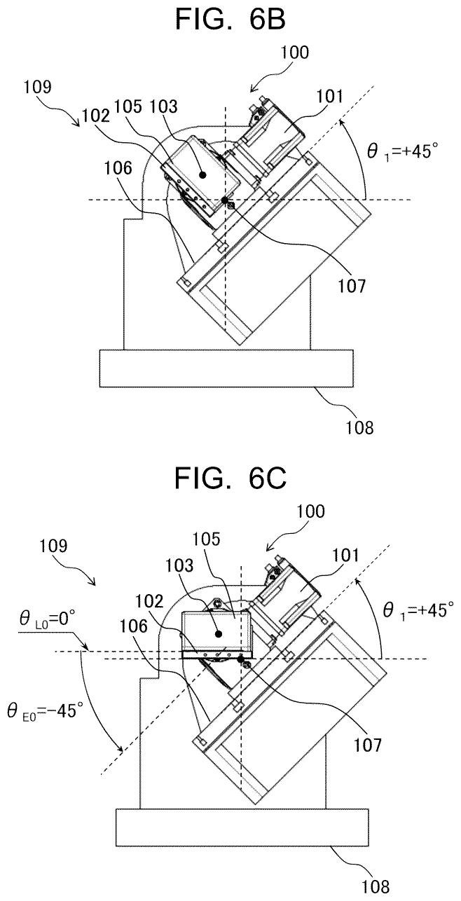

The measurement device 100 may be configured to measure a relative difference θ₁−θ₀ in incline angle between the first measurement surface 112 and the second measurement surface 113 based on the first incline angle θ₁−θ₀ of the first measurement surface 112 with respect to the measurement reference plane 108 and the second incline angle θ₂−θ₀ of the second measurement surface 113 with respect to the measurement reference plane 108. Note that the incline angles of the measurement reference plane 108, first measurement surface 112, and second measurement surface 113 may be measured by the single measurement device 100 or the incline angles of the measurement reference plane 108, first measurement surface 112, and second measurement surface 113 may be measured by two or more measurement devices 100.

Whereas in FIGS. 3A to 3C, the measurement surface 106 of the tilting rotary table 109 is rotating clockwise, the measurement surface 106 of the tilting rotary table 109 may rotate counterclockwise as shown in FIGS. 6A to 6C. As shown in FIGS. 3A to 3C, after rotating the measurement surface 106 clockwise, the rotation mechanism 101 is rotating the support member 102 counterclockwise. On the other hand, as shown in FIGS. 6A and 6C, if the rotation mechanism 101 simply rotates the support member 102 clockwise after rotating the measurement surface 106 counterclockwise, because of the difference in the rotation direction of the support member 102, a hysteresis error may occur in the rotation angle detected by the angle detector 104 and/or the incline angle detected by the incline detector 105. This in turn may produce a hysteresis error in the measured incline angle of the measurement surface 106. Therefore, to curb hysteresis error in the measured incline angle of the measurement surface 106, the rotation mechanism 101 may rotate the support member 102 in one predetermined direction when the incline detector 105 detects the incline angle of the support member 102 with respect to the measurement reference plane 108. For example, as shown in FIG. 6B, after rotating the measurement surface 106 counterclockwise, the rotation mechanism 101 rotates the support member 102 clockwise such that the incline detector 105 will overrun by overshooting the incline angle at which the incline detector 105 becomes roughly parallel to the measurement reference plane 108. Subsequently, as shown in FIG. 6C, the rotation mechanism 101 rotates the support member 102 counterclockwise such that the incline detector 105 will be roughly parallel to the measurement reference plane 108. In this way, as shown in FIGS. 3C and 6C, when the incline detector 105 detects the incline angle of the support member 102 with respect to the measurement reference plane 108, the rotation mechanism 101 rotates the support member 102 counterclockwise, making it possible to curb hysteresis error of the measurement device 100 itself at the measured incline angle of the measurement surface 106. As shown in FIG. 6A, after rotating the measurement surface 106 counterclockwise, without rotating the support member 102 clockwise, the rotation mechanism 101 may rotate the support member 102 counterclockwise such that the incline detector 105 will be roughly parallel to the measurement reference plane 108. Note that the procedures for the tilting rotary table 109 similarly apply to the robot arm 110.

The measurement surface 106 may be configured to rotate around the inclined rotation axis 107 based on a predetermined rotation angle. The measurement surface 106 is rotated around the inclined rotation axis 107 to the predetermined rotation angle. The rotation mechanism 101 rotates the support member 102 according to the predetermined rotation angle such that the incline detector 105 will be roughly parallel to the measurement reference plane 108. At the predetermined rotation angle of the measurement surface 106, the rotation angle of the support member 102 is detected by the angle detector 104 and the incline angle of the support member 102 with respect to the measurement reference plane 108 is detected by the incline detector 105. The measurement device 100 may be configured to measure the incline angle of the measurement surface 106 with respect to the measurement reference plane 108 according to the predetermined rotation angle based on the rotation angle detected by the angle detector 104 and the incline angle detected by the incline detector 105. This makes it possible to obtain a difference between a positioning command angle of the measurement surface 106 around the inclined rotation axis 107 and the incline angle of the measurement surface 106 with respect to the measurement reference plane 108.

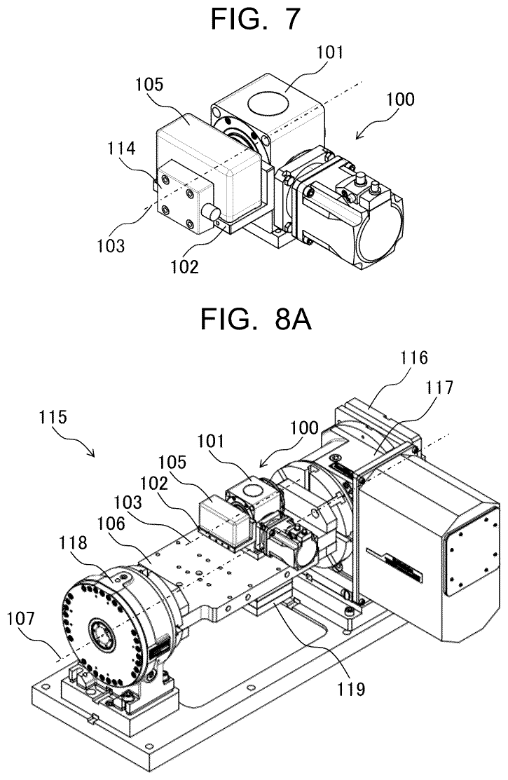

As shown in FIG. 7, the measurement device 100 may further include an incline sensor 114. The incline sensor 114 detects the incline angle of the support member 102 with respect to the measurement reference plane 108. In using a level gauge capable of measuring an incline angle with high accuracy on the order of 1/3600° or less as the incline detector 105, the measuring range of such a level gauge is extremely narrow—as narrow as a range of −1° to +1°. The rotation mechanism 101 may rotate the support member 102 using that incline angle of the support member 102 with respect to the measurement reference plane 108 which is detected by the incline sensor 114 such that the incline angle of the support member 102 with respect to the measurement reference plane 108 will fall within a predetermined range in which the incline detector 105 can measure the incline angle with high accuracy. Although the incline sensor 114 used can measure a wide range of incline angles, it is sufficient if the incline sensor 114 can measure incline angles with a resolution as low as 0.1° or less and an accuracy as low as in a range of −0.1°to 0.1°. The measurement device 100 may be configured to measure the incline angle of the measurement surface 106 with respect to the measurement reference plane 108 based on the rotation angle along with rotation of the support member 102 detected by the angle detector 104 and on the incline angle detected by the incline detector 105 if the incline angle detected by the incline sensor 114 falls within a predetermined range.

After the measurement surface 106 is rotated around the inclined rotation axis 107, the rotation mechanism 101 rotates the support member 102 around the support member axis 103. Subsequently, the measurement device 100 may be configured to measure the incline angle of the measurement surface 106 with respect to the measurement reference plane 108 based on the rotation angle along with rotation of the support member 102 detected by the angle detector 104 and on that incline angle of the support member 102 with respect to the measurement reference plane 108 which is detected by the incline detector 105, and an indexing operation may be performed in this way. As the rotation mechanism 101 rotates the support member 102 around the support member axis 103 while the measurement surface 106 is rotating around the inclined rotation axis 107, the measurement device 100 may be configured to subsequently measure the incline angle of the measurement surface 106 with respect to the measurement reference plane 108 based on the rotation angle along with rotation of the support member 102 detected by the angle detector 104 and on that incline angle of the support member 102 with respect to the measurement reference plane 108 which is detected by the incline detector 105. In this way, these operations may be performed successively.

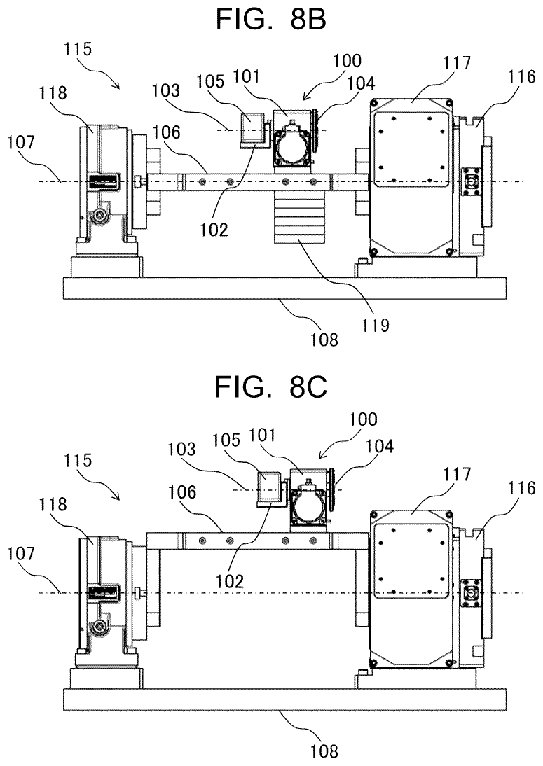

FIGS. 8A to 8C show the measurement device 100 placed on the measurement surface 106 of an evaluation device 115. The evaluation device 115 includes a drive table 117 for use to rotate the measurement surface 106 and a driven table 118 for use to assist loading. The drive table 117 is connected with a conventional measurement device 116 for comparison with measured values obtained by the measurement device 100. Examples of the conventional measurement device 116 include encoders, autocollimators, and laser goniometers. In the evaluation device 115 shown in FIG. 8B, the height of the measurement surface 106 is adjusted to make the center of gravity of the measurement surface 106 match the inclined rotation axis 107 and a counterweight 119 is provided on the side opposite the measurement surface 106 to balance weight with the measurement device 100 placed on the measurement surface 106. In the evaluation device 115 shown in FIG. 8C, the height of the measurement surface 106 has been adjusted to offset the center of gravity of the measurement surface 106 from the inclined rotation axis 107.

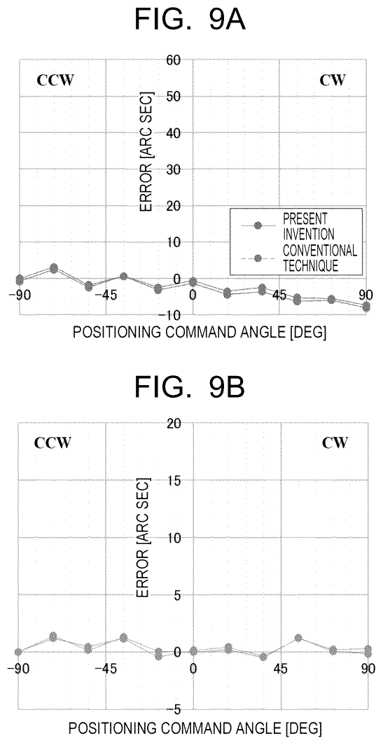

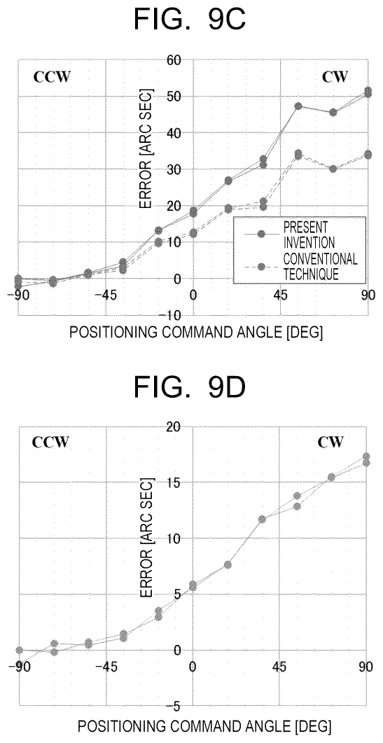

FIG. 9A shows a graphic chart of positioning command angle versus angular measurement error concerning the measurement device 100 of the present invention and the conventional measurement device 116 both placed on the evaluation device 115 of FIG. 8B. The positioning command angle is a rotation angle of the inclined rotation axis 107 from a reference angle. The angular measurement error is a difference between the positioning command angle and the measured incline angle. FIG. 9B is a graphic chart of differences (instrumental errors) in a positioning command angle versus angular measurement error relationship between the measurement device 100 of the present invention and the conventional measurement device 116 both placed on the evaluation device 115 of FIG. 8B. FIG. 9C shows a graphic chart of positioning command angle versus angular measurement error concerning the measurement device 100 of the present invention and the conventional measurement device 116 both placed on the evaluation device 115 of FIG. 8C. FIG. 9D is a graphic chart of differences (instrumental errors) in a positioning command angle versus angular measurement error relationship between the measurement device 100 of the present invention and the conventional measurement device 116 both placed on the evaluation device 115 of FIG. 8C. When FIG. 9A and FIG. 9C are compared, it can be seen that the center of gravity of the measurement surface 106 is offset from the inclined rotation axis 107, thereby producing an offset load, consequently causing the incline angle of the measurement surface 106 with respect to the measurement reference plane 108 to fail to match the positioning command angle, and resulting in increases in positioning error in FIG. 9C compared to FIG. 9A. When FIG. 9B and FIG. 9D are compared, it can be seen that whereas the instrumental error is 2 arcsec in FIG. 9B, in FIG. 9D, the instrumental error is as large as 18 arcsec. This indicates that as a result of the offset load, the incline angle measured by the conventional measurement device 116 connected to the drive table 117 does not match the incline angle of the measurement surface 106 with respect to the actual measurement reference plane 108. In this way, when the incline angle of the measurement surface 106 is directly measured with respect to the measurement reference plane 108 with the measurement device 100 placed on the measurement surface 106, the incline angle of the measurement surface 106 with respect to the measurement reference plane 108 can be measured with high accuracy.

It should be further understood by persons skilled in the art that although the foregoing description has been made on embodiments of the present invention, the present invention is not limited thereto and various changes and modifications may be made without departing from the principle of the present invention and the scope of the appended claims.

### REFERENCE SIGNS LIST

100 measurement device
101 rotation mechanism
102 support member
103 support member axis
104 angle detector
105 incline detector
106 measurement surface
107 inclined rotation axis
108 measurement reference plane
109 tilting rotary table
110 robot arm
111 end effector
112 first measurement surface
113 second measurement surface
114 incline sensor
115 evaluation device
116 conventional measurement device
117 drive table
118 driven table
119 counterweight

1. A measurement device measuring an incline angle of a measurement surface with respect to a measurement reference plane, the measurement device comprising:
a rotation mechanism;
a support member rotatable around a support member axis by means of the rotation mechanism;
an angle detector detecting a rotation angle of the support member; and
an incline detector placed on the support member and detecting an incline angle of the support member with respect to the measurement reference plane, wherein
the measurement device is placed on the measurement surface,
the rotation mechanism rotates the support member such that the incline detector is roughly parallel to the measurement reference plane, and
the measurement device is configured to measure the incline angle of the measurement surface with respect to the measurement reference plane based on the rotation angle along with rotation of the support member detected by the angle detector and on the incline angle detected by the incline detector.

2. The measurement device according to claim 1, wherein the rotation mechanism rotates the support member such that the incline detector is parallel to the measurement reference plane based on the incline angle detected by the incline detector.

3. The measurement device according to claim 1, wherein the incline detector is a level gauge.

4. The measurement device according to claim 1, wherein:
the measurement surface is configured to rotate around an inclined rotation axis;
the rotation mechanism rotates the support member along with rotation of the measurement surface; and
the measurement device is configured to measure a rotation angle of the measurement surface by measuring the incline angle of the measurement surface with respect to the measurement reference plane along with rotation of the measurement surface.

5. The measurement device according to claim 4, wherein the measurement device is placed on the measurement surface such that the support member axis is parallel to the inclined rotation axis.

6. The measurement device according to claim 4, wherein when the incline detector detects the incline angle of the support member with respect to the measurement reference plane, the rotation mechanism rotates the support member in one predetermined direction.

7. The measurement device according to claim 4, wherein:
the measurement surface is configured to rotate based on a predetermined rotation angle;
the rotation mechanism rotates the support member according to the predetermined rotation angle; and
the measurement device is configured to measure the incline angle of the measurement surface with respect to the measurement reference plane according to the predetermined rotation angle.

8. The measurement device according to claim 4, further comprising an incline sensor, wherein:
the rotation mechanism rotates the support member such that the incline angle of the support member with respect to the measurement reference plane, detected by the incline sensor, falls within a predetermined range; and
when the incline angle detected by the incline sensor falls within the predetermined range, the measurement device is configured to measure the incline angle of the measurement surface with respect to the measurement reference plane based on the incline angle detected by the incline detector.

9. The measurement device according to claim 4, wherein:
the rotation mechanism rotates the support member while the measurement surface is rotating; and while the measurement surface is rotating, the measurement device is configured to measure the incline angle of the measurement surface with respect to the measurement reference plane.

10. The measurement device according to claim 1, wherein:
the measurement surface is a first measurement surface; and
after measuring a first incline angle of the first measurement surface with respect to the measurement reference plane, the measurement device is configured to be placed on a second measurement surface different from the first measurement surface, measure a second incline angle of the second measurement surface with respect to the measurement reference plane, and measure a relative difference in incline angle between the first measurement surface and the second measurement surface based on the first incline angle and the second incline angle.
